(19) United States
(12) Patent Application Publication
(10) Pub. No.: US 2012/0181244 A1
(43) Pub. Date: Jul. 19, 2012

(54) COMBINATION HOOK RACK

(76) Inventor: WEN-TSAN WANG, Taipei city (TW)

(21) Appl. No.: 13/006,405

(22) Filed: Jan. 13, 2011

(51) Int. Cl. F16B 45/00

(52) U.S. Cl. 211/106.01

(57) ABSTRACT

A combination hook rack includes a rack frame formed of two elongated frame plates and spacer blocks fixedly set in between the two elongated frame plates and kept apart from one another at a distance, hanging belts affixed to the rack frame and provided with a respective hook at the free end for hanging the rack frame on a high place, and hanging hooks affixed to the rack frame for hanging things, each hanging hook having a hooked lower part suspending outside the rack frame and one open space transversely formed in the hooked lower part between each two adjacent hanging portions of the hooked lower part.

### BACKGROUND OF THE INVENTION

a) Field of the Invention

The present invention relates to hook racks for hanging things and more particularly to a combination hook rack that can be used in a limited space area for hanging a big number of things.

b) Description of the Related Art

Clothes trees and hook racks may be used in houses for hanging clothes, hats, handbags, shopping bags and many other things. In order to fully utilize the limited house space, hanging hooks may be affixed to the back panel of the door of a room for hanging things.

People may adhere or affix hanging hooks individually to the back panel of a door at selected locations for hanging things. Several hanging hooks may be arranged together and affixed to the back panel of a door to form a hook rack. Some commercial hanging hooks provide one single hook portion for hanging things. Some other commercial hanging hooks provide multiple hook portions for hanging things. Further, a regular hook rack has a fixed number of hooks for hanging. The number of hooks of a regular hook rack is not adjustable to fit different application requirements.

### SUMMARY OF THE INVENTION

The present invention has been accomplished under the circumstances in view. It is one object of the present invention to provide a combination hook rack, which is expandable for use in a limited space area for hanging a big number of things.

To achieve this and other objects of the present invention, a combination hook rack comprises a rack frame, and a plurality of hanging hooks. The rack frame comprises two elongated frame plates arranged in parallel, a plurality of spacer blocks fixedly set in between the two elongated frame plates, and an open space defined between each two adjacent spacer blocks within the two elongated frame plates. The hanging hooks are affixed to the rack frame for hanging things. Each hanging hook is formed of a plurality of flat bars bonded together and then bent into a predetermined shape. Each hanging hook comprises a hooked lower part. The hooked lower part comprises a plurality of hanging portions disposed at different elevations and an open space transversely formed in the hooked lower part between each two adjacent hanging portions.

Further, movable hook members are selectively detachably hooked in the open space defined between each two adjacent spacer blocks and supported on the front-sided elongated frame plate of the rack frame for hanging things.

Further, hanging belts can be affixed to the rack frame for hanging the rack frame on a high place, for example, the top edge of a door in a house. Each hanging belt has one end thereof affixed to the rack frame and an opposite end thereof provided with a hook for hanging.

### BRIEF DESCRIPTION OF THE DRAWINGS

FIG. 1 is an elevational view of a hanging hook for combination hook rack in accordance with a first embodiment of the present invention.

FIG. 2 is an elevational view of a hanging hook for combination hook rack in accordance with a second embodiment of the present invention.

FIG. 3 is an elevational view of a hanging hook for combination hook rack in accordance with a third embodiment of the present invention.

FIG. 4 is an elevational view of a hanging hook for combination hook rack in accordance with a four embodiment of the present invention.

FIG. 5 is an exploded view of a combination hook rack in accordance with the present invention.

FIG. 6 illustrates a combination hook used with movable hook members and hanging hooks prepared according to the first embodiment of the present invention.

FIG. 7 illustrates a combination hook used with movable hook members and hanging hooks prepared according to the second embodiment of the present invention.

FIG. 8 illustrates a combination hook provided with hanging belts and used with movable hook members according to the present invention.

### DETAILED DESCRIPTION OF THE PREFERRED EMBODIMENT

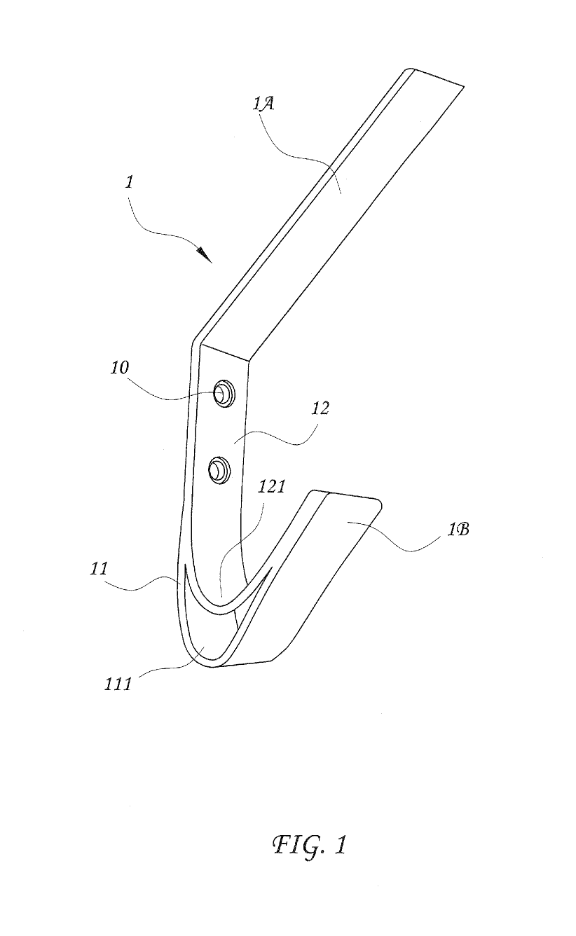

Referring to FIG. 1, a hanging hook 1 for combination hook rack in accordance with a first embodiment of the present invention is formed of a first flat bar 11 and a second flat bar 12. The first flat bar 11 and the second flat bar 12 are bonded together and then bent into a predetermined shape having an obliquely forwardly tilted straight upper part 1A and a hooked lower part 1B where a part of the first flat bar 11 forms a first hanging portion 111 on the middle of the hooked lower part 1B, and a part of the second flat bar 12 forms a second hanging portion 121 on the middle of the hooked lower part 1B and spaced above the first hanging portion 111. Thus, an open space is transversely formed in the hooked lower part 1B between the first hanging portion 111 and the second hanging portion 121. Further, the obliquely forwardly tilted straight upper part 1A can be made relatively longer than the hooked lower part 1B. Alternatively, the obliquely forwardly tilted straight upper part 1A can be made relatively shorter than the hooked lower part 1B. Further, the hanging hook 1 can be processed to provide mounting through holes 10 at suitable locations, for example, near the top side of the hooked lower part 1B at different elevations.

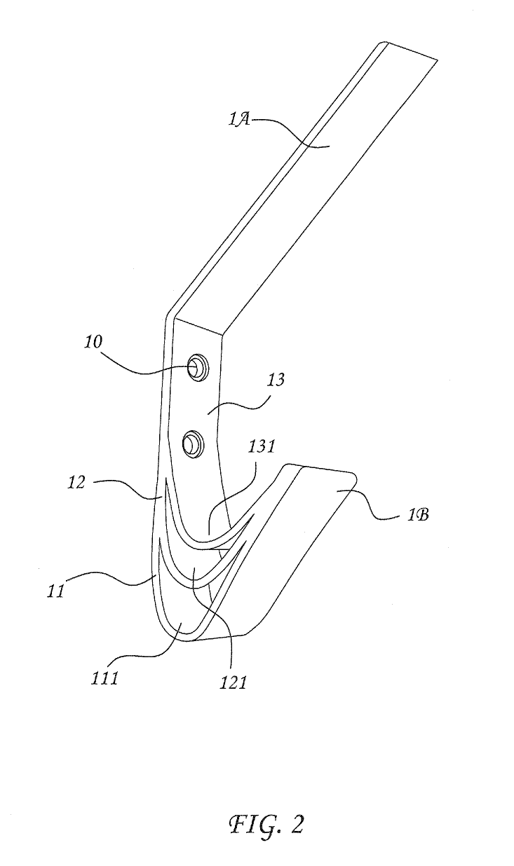

FIG. 2 illustrates a hanging hook 1 for combination hook rack in accordance with a second embodiment of the present invention, which is formed of a first flat bar 11, a second flat bar 12 and a third flat bar 13. The first flat bar 11, the second flat bar 12 and the third flat bar 13 are bonded together and then bent into a predetermined shape having an obliquely forwardly tilted straight upper part 1A and a hooked lower part 1B where a part of the first flat bar 11 forms a first hanging portion 111 on the middle of the hooked lower part 1B, a part of the second flat bar 12 forms a second hanging portion 121 on the middle of the hooked lower part 1B and spaced above the first hanging portion 111, and a part of the third flat bar 13 forms a third hanging portion 131 on the middle of the hooked lower part 1B and spaced above the second hanging portion 1231. Thus, an open space is transversely formed in the hooked lower part 1B between each two adjacent ones of the first hanging portion 111, second hanging portion 121 and third hanging portion 131. Further, the obliquely forwardly tilted straight upper part 1A can be made relatively longer than the hooked lower part 1B. Alternatively, the obliquely forwardly tilted straight upper part 1A can be made relatively shorter than the hooked lower part 1B. Further, the hanging hook 1 can be processed to provide mounting through holes 10 at suitable locations, for example, near the top side of the hooked lower part 1B at different elevations.

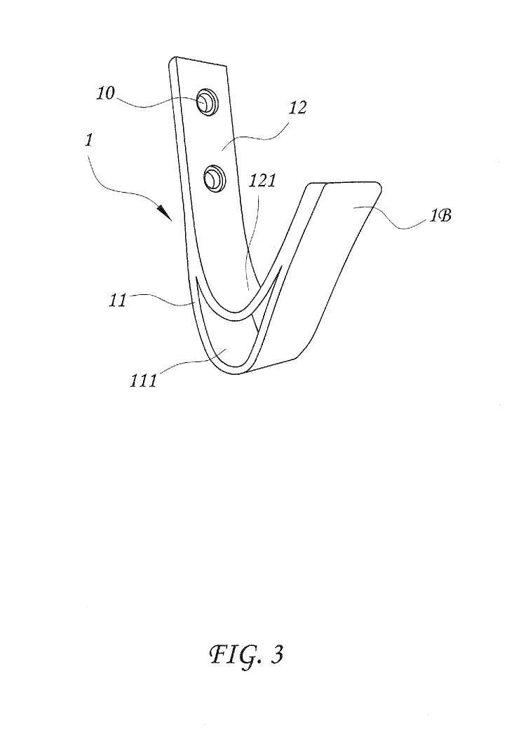

FIG. 3 illustrates a hanging hook 1 for combination hook rack in accordance with a third embodiment of the present, which is formed of a first flat bar 11 and a second flat bar 12. The first flat bar 11 and the second flat bar 12 are bonded together and then bent into a predetermined shape having an obliquely forwardly tilted hooked lower part 1B where a part of the first flat bar 11 forms a first hanging portion 111 on the middle of the hooked lower part 1B, and a part of the second flat bar 12 forms a second hanging portion 121 on the middle of the hooked lower part 1B and spaced above the first hanging portion 111. Thus, an open space is transversely formed in the hooked lower part 1B between the first hanging portion 111 and the second hanging portion 121. Further, the hanging hook 1 can be processed to provide mounting through holes 10 at suitable locations for mounting.

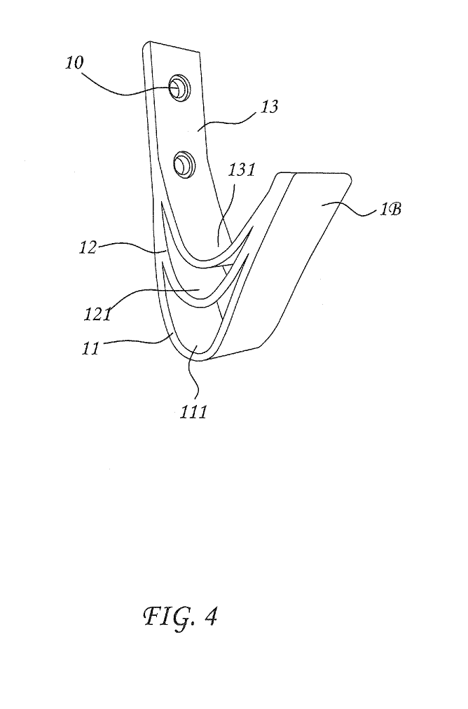

FIG. 4 illustrates hanging hook 1 for combination hook rack in accordance with a fourth embodiment of the present invention is formed of a first flat bar 11, a second flat bar 12 and a third flat bar 13. The first flat bar 11, the second flat bar 12 and the third flat bar 13 are bonded together and then bent into a predetermined shape having an obliquely forwardly tilted hooked lower part 1B where a part of the first flat bar 11 forms a first hanging portion 111 on the middle of the hooked lower part 1B, a part of the second flat bar 12 forms a second hanging portion 121 on the middle of the hooked lower part 1B and spaced above the first hanging portion 111, and a part of the third flat bar 13 forms a third hanging portion 131 on the middle of the hooked lower part 1B and spaced above the second hanging portion 121. Thus, an open space is transversely formed in the hooked lower part 1B between each two adjacent ones of the first hanging portion 111, second hanging portion 121 and third hanging portion 131. Further, the hanging hook 1 can be processed to provide mounting through holes 10 at suitable locations for mounting.

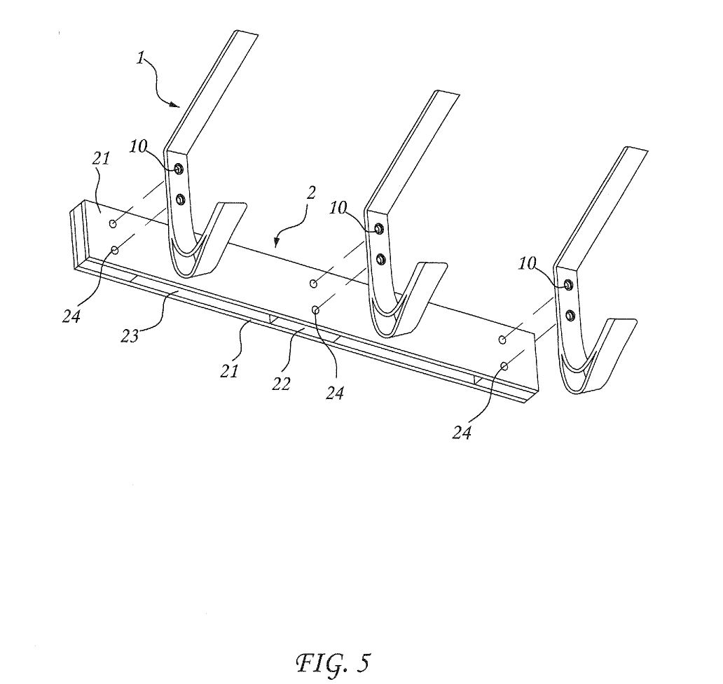

Referring to FIG. 5, a combination hook rack is shown comprising a rack frame 2 and a plurality of hanging hooks 1 prepared according to the first embodiment of the present invention and affixed to the rack frame 2. The rack frame 2 comprises two elongated frame plates 21 arranged in parallel, a plurality of spacer blocks 22 fixedly set in between the two elongated frame plates 21, an open space defined between each two adjacent spacer blocks 22 within the two elongated frame plates 21, and multiple sets of mounting through holes 24 cut through the front-sided elongated frame plate 21 corresponding to the mounting through holes 10 of each of the hanging hooks 1. Fastening members, for example, screws (not shown) are fastened to the mounting through holes 10 of the hanging hooks 1 and the mounting through holes 24 of the rack frame 2 to affix the hanging hooks 1 to the rack frame 2.

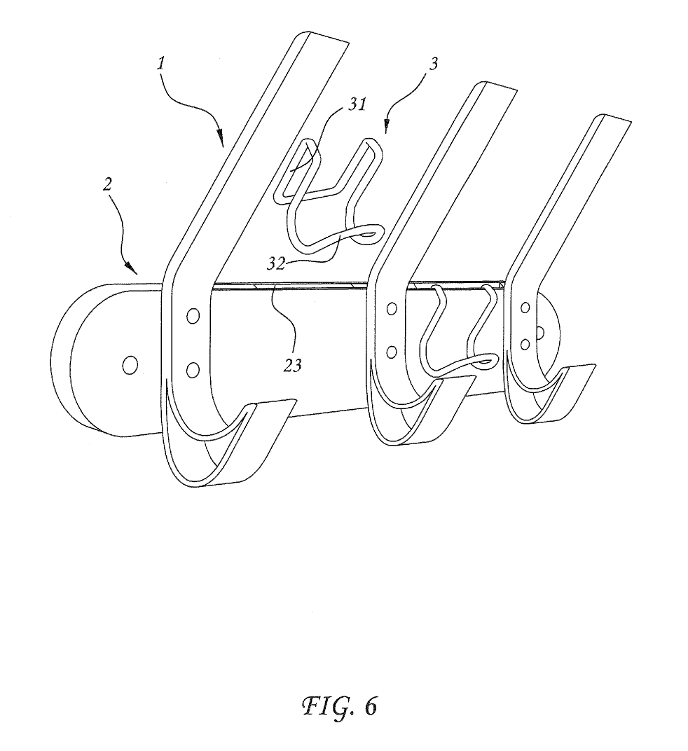

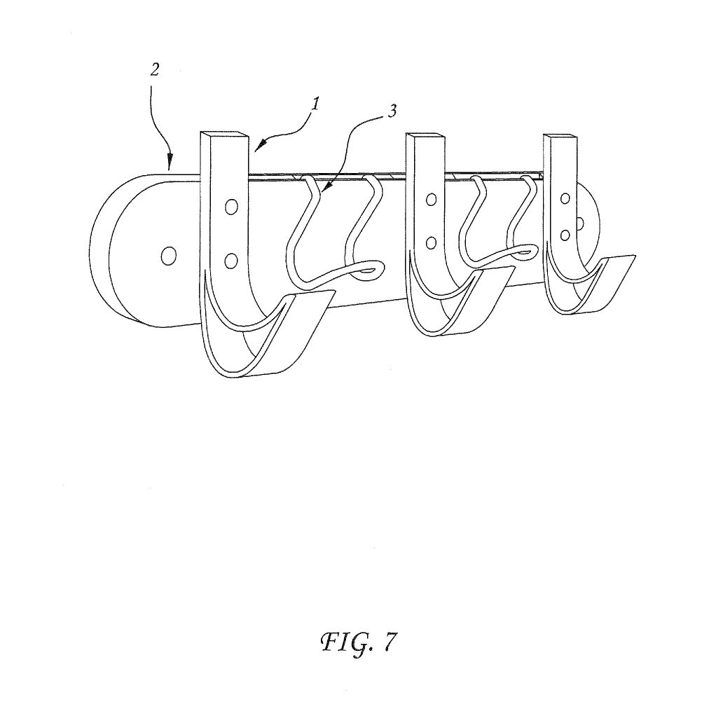

Referring to FIG. 6 and FIG. 7, movable hook members 3 can be respectively and detachably hung in each open space between each two adjacent spacer blocks 22 of the rack frame 2 of the combination hook rack within the two elongated frame plates 21 and supported on the front-sided elongated frame plate 21 of the rack frame 2 for hanging things. The movable hook members 3 are respectively made by bending a metal wire rod into shape, each having a first hook portion 31 for hooking in one open space between two adjacent spacer blocks 22 of the rack frame 2 within the two elongated frame plates 21 and a second hook portion 32 for supporting on the front side of the elongated frame plate 21 of the rack frame 2 for hanging things.

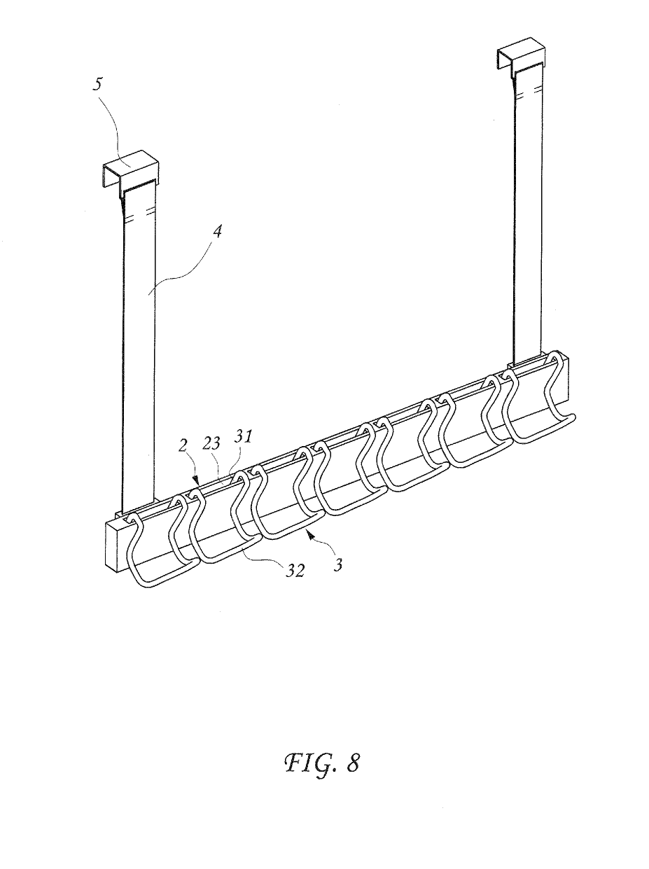

Referring to FIG. 8, a plurality of hanging belts 4 can be fastened to the rack frame 2 of the combination hook rack for hanging the combination hook rack on, for example, the top edge of a door in a house. Each hanging belt 4 has one end affixed to the rack frame 2, and the other end provided with a hook 5 for hanging.

Although particular embodiments of the invention have been described in detail for purposes of illustration, various modifications and enhancements may be made without departing from the spirit and scope of the invention. Accordingly, the invention is not to be limited except as by the appended claims.

I claim:

1. A combination hook rack, comprising:
a rack frame, said rack frame comprising two elongated frame plates arranged in parallel, a plurality of spacer blocks fixedly set in between said two elongated frame plates and an open space defined between each two adjacent ones of said spacer blocks within said two elongated frame plates; and
a plurality of hanging hooks affixed to said rack frame for hanging things, each said hanging hook being formed of a plurality of flat bars bonded together and then bent into a predetermined shape, each said hanging hook comprising a hooked lower part, said hooked lower part comprising a plurality of hanging portions disposed at different elevations and an open space transversely formed in said hooked lower part between each two adjacent hanging portions.

2. The combination hook rack as claimed in claim 1, further comprising a plurality of movable hook members respectively detachably hooked in the open space defined between each two adjacent said spacer blocks and supported on one said elongated frame plate for hanging things.

3. The combination hook rack as claimed in claim 1, further comprising a plurality of hanging belts affixed to said rack frame for hanging said rack frame on a high place, each said hanging belt having one end thereof affixed to said rack frame and an opposite end thereof provided with a hook for hanging.
